(19) United States
(12) Patent Application Publication
(10) Pub. No.: US 2023/0070512 A1
(43) Pub. Date: Mar. 9, 2023

(54) SECONDARY BATTERY

(71) Applicant: MURATA MANUFACTURING CO., LTD., Kyoto (JP)

(72) Inventors: Rie WATANABE, Kyoto (JP); Taichi KATSUMOTO, Kyoto (JP); Masayuki KAGEYAMA, Kyoto (JP)

(21) Appl. No.: 17/986,106

(22) Filed: Nov. 14, 2022

Related U.S. Application Data
(63) Continuation of application No. PCT/JP2020/046513, filed on Dec. 14, 2020.

(30) Foreign Application Priority Data
May 14, 2020 (JP) 2020-085529

(51) Int. Cl. H01M 10/04; H01M 4/04; H01M 50/46; H01M 10/0525; H01M 50/153; H01M 50/169; H01M 50/531

(52) U.S. Cl. CPC H01M 10/0427; H01M 4/0404; H01M 10/0431; H01M 10/0525; H01M 50/46; H01M 50/153; H01M 50/169; H01M 50/531

(57) ABSTRACT

A secondary battery includes an outer package member, a battery device, and an insulating member. The battery device is contained inside the outer package member, and includes a positive electrode and a negative electrode that are opposed to each other and are wound. The insulating member is provided on the positive electrode. The positive electrode includes a positive electrode current collector, and a positive electrode active material layer provided on the positive electrode current collector. The negative electrode includes a negative electrode current collector, and a negative electrode active material layer provided on the negative electrode current collector on a side opposed to the positive electrode active material layer. The positive electrode includes an exposed part in which the positive electrode active material layer is not provided and the positive electrode current collector is exposed. The exposed part is opposed to the negative electrode active material layer. The insulating member covers at least the exposed part. The positive electrode has a first direction along which the positive electrode active material layer is provided intermittently via the exposed part on the positive electrode current collector, and a second direction intersecting the first direction. In the second direction, the negative electrode protrudes relative to the positive electrode toward opposite sides. Further, in the second direction, the insulating member protrudes relative to the positive electrode toward the opposite sides. A dimension of the positive electrode in the second direction, a dimension of the negative electrode in the second direction, a dimension of protrusion of the insulating member relative to the positive electrode on one of the opposite sides in the second direction, and a dimension of protrusion of the insulating member relative to the positive electrode on another of the opposite sides in the second direction satisfy a relationship represented by Expression (1) below.

$$0.50 \leq \left(\text{W3} \text{+} \text{W4}\right) / \left(\text{W2} - \text{W1}\right) \leq 3.00$$

where:
W1 is the dimension of the positive electrode in the second direction;
W2 is the dimension of the negative electrode in the second direction;
W3 is the dimension of protrusion of the insulating member relative to the positive electrode on the one of the opposite sides in the second direction; and
W4 is the dimension of protrusion of the insulating member relative to the positive electrode on the other of the opposite sides in the second direction.

### CROSS REFERENCE TO RELATED APPLICATIONS

The present application is a continuation of PCT Pat. Application No. PCT/JP2020/046513, filed on Dec. 14, 2020, which claims priority to Japanese patent application no. JP2020-085529, filed on May 14, 2020, the entire contents of which are herein incorporated by reference.

### BACKGROUND

The present technology relates to a secondary battery.

Various kinds of electronic equipment, including mobile phones, have been widely used. Such widespread use has promoted development of a secondary battery as a power source that is smaller in size and lighter in weight and allows for a higher energy density. The secondary battery includes a positive electrode, a negative electrode, and an electrolyte that are contained inside an outer package member. A configuration of the secondary battery has been considered in various ways.

Specifically, in order to prevent a short circuit between an electrode plate and a case, a protective tape is provided on each of a positive electrode tab, a negative electrode tab, a positive electrode uncoated area, and a negative electrode uncoated area. In order to suppress a short circuit of an electrode body, an electrode plate is cut and a protective tape is attached to a cut edge of the electrode plate in a process of manufacturing a wound electrode body.

### SUMMARY

The present technology relates to a secondary battery.

Consideration has been given in various ways to improve performance of a secondary battery; however, the secondary battery still remains insufficient in operational reliability and manufacturing stability. Accordingly, there is still room for improvement in terms thereof.

The present technology has been made in view of such an issue and relates to providing a secondary battery that is able to achieve high operational reliability and superior manufacturing stability according to an embodiment.

A secondary battery according to an embodiment of the present technology includes an outer package member, a battery device, and an insulating member. The battery device is contained inside the outer package member. The positive electrode and the negative electrode are opposed to each other and are wound. The insulating member is provided on the positive electrode. The positive electrode includes a positive electrode current collector, and a positive electrode active material layer provided on the positive electrode current collector. The negative electrode includes a negative electrode current collector, and a negative electrode active material layer provided on the negative electrode current collector on a side opposed to the positive electrode active material layer. The positive electrode includes an exposed part in which the positive electrode active material layer is not provided and the positive electrode current collector is exposed. The exposed part is opposed to the negative electrode active material layer. The insulating member covers at least the exposed part. The positive electrode has a first direction along which the positive electrode active material layer is provided intermittently via the exposed part on the positive electrode current collector, and a second direction intersecting the first direction. In the second direction, the negative electrode protrudes relative to the positive electrode toward opposite sides. Further, in the second direction, the insulating member protrudes relative to the positive electrode toward the opposite sides. A dimension of the positive electrode in the second direction, a dimension of the negative electrode in the second direction, a dimension of protrusion of the insulating member relative to the positive electrode on one of the opposite sides in the second direction, and a dimension of protrusion of the insulating member relative to the positive electrode on another of the opposite sides in the second direction satisfy a relationship represented by Expression (1) below.

$$0.50 \leq \left(\text{W3+W4}\right) / \left(\text{W2-W1}\right) \leq 3.00$$

where:
W1 is the dimension of the positive electrode in the second direction;
W2 is the dimension of the negative electrode in the second direction;
W3 is the dimension of protrusion of the insulating member relative to the positive electrode on the one of the opposite sides in the second direction; and W4 is the dimension of protrusion of the insulating member relative to the positive electrode on the other of the opposite sides in the second direction.

According to the secondary battery of an embodiment, the relationship represented by Expression (1) is satisfied regarding the positive electrode, the negative electrode, and the insulating member. This makes it possible to achieve high operational reliability and superior manufacturing stability.

Note that effects of the present technology are not necessarily limited to those described above and may include any of a series of effects described below in relation to the present technology.

### BRIEF DESCRIPTION OF THE FIGURES

FIG. 1 is a perspective view of a configuration of a secondary battery according to an embodiment of the present technology.

FIG. 2 is a sectional view of the configuration of the secondary battery illustrated in FIG. 1.

FIG. 3 is a sectional view of a configuration of a battery device illustrated in FIG. 2.

FIG. 4 is a plan view of a configuration of each of a positive electrode and a negative electrode illustrated in FIG. 3.

FIG. 5 is a sectional view of the configuration of each of the positive electrode and the negative electrode illustrated in FIG. 3.

FIG. 6 is another plan view of the configuration of the positive electrode illustrated in FIG. 3.

FIG. 7 is a sectional view of a configuration of a main part of the secondary battery illustrated in FIG. 2.

FIG. 8 is a perspective view of a configuration of an outer package can to be used in a process of manufacturing the secondary battery.

FIG. 9 is a sectional diagram for describing the process of manufacturing the secondary battery.

FIG. 10 is a sectional view of a configuration of a main part of a secondary battery according to a first reference example.

FIG. 11 is a sectional view of a configuration of a main part of a secondary battery according to a second reference example.

### DETAILED DESCRIPTION

One or more embodiments of the present technology are described below in further detail including with reference to the drawings.

A description is given first of a secondary battery according to an embodiment of the present technology.

The secondary battery to be described here has a flat and columnar three-dimensional shape, and is commonly referred to by a term such as a coin type or a button type. As will be described later, the secondary battery includes two bottom parts opposed to each other, and a sidewall part lying between the two bottom parts. This secondary battery has a height smaller than an outer diameter. The “outer diameter” is a diameter (a maximum diameter) of each of the two bottom parts. The “height” is a distance (a maximum distance) from a surface of one of the bottom parts to a surface of another of the bottom parts.

Although a charge and discharge principle of the secondary battery is not particularly limited, the following description deals with a case where a battery capacity is obtained using insertion and extraction of an electrode reactant. The secondary battery includes a positive electrode, a negative electrode, and an electrolyte. In the secondary battery, to prevent precipitation of the electrode reactant on a surface of the negative electrode during charging, a charge capacity of the negative electrode is greater than a discharge capacity of the positive electrode. In other words, an electrochemical capacity per unit area of the negative electrode is set to be greater than an electrochemical capacity per unit area of the positive electrode.

Although not particularly limited in kind, the electrode reactant is specifically a light metal such as an alkali metal or an alkaline earth metal. Examples of the alkali metal include lithium, sodium, and potassium. Examples of the alkaline earth metal include beryllium, magnesium, and calcium.

Examples are given below of a case where the electrode reactant is lithium. A secondary battery that obtains the battery capacity using insertion and extraction of lithium is a so-called lithium-ion secondary battery. In the lithium-ion secondary battery, lithium is inserted and extracted in an ionic state.

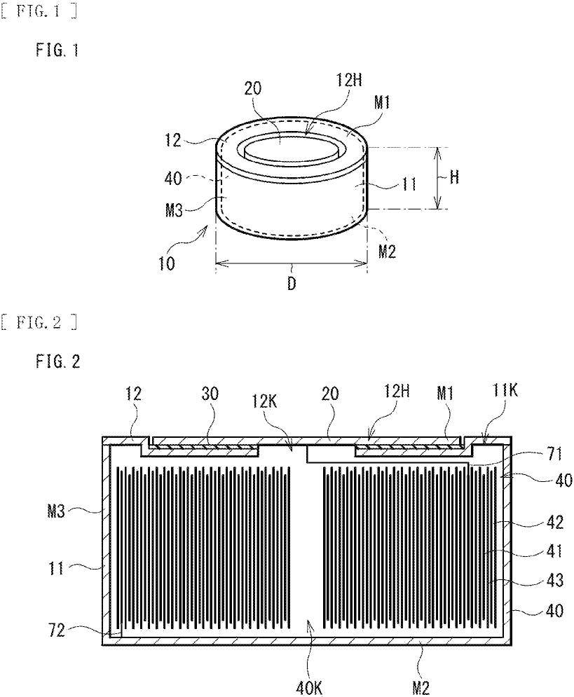

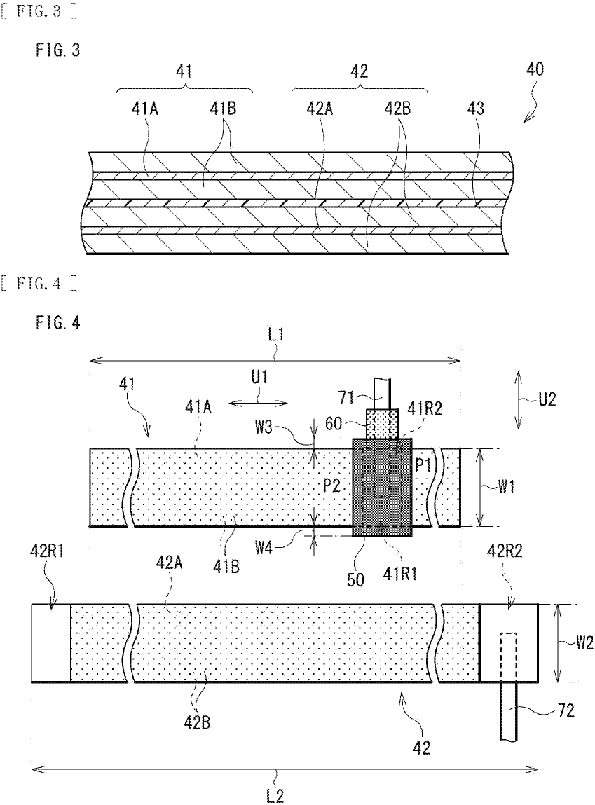

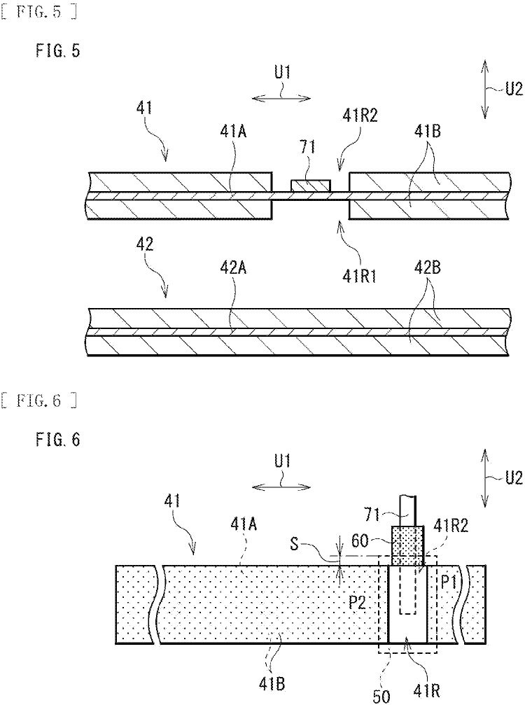

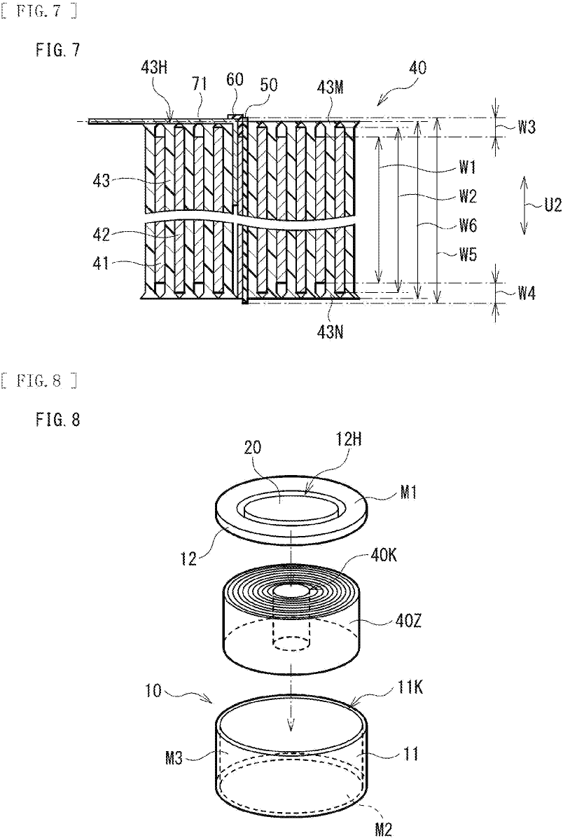

FIG. 1 illustrates a perspective configuration of the secondary battery. FIG. 2 illustrates a sectional configuration of the secondary battery illustrated in FIG. 1. FIG. 3 illustrates a sectional configuration of a battery device 40 illustrated in FIG. 2. FIG. 4 illustrates a planar configuration of each of a positive electrode 41 and a negative electrode 42 illustrated in FIG. 3. FIG. 5 illustrates a sectional configuration of each of the positive electrode 41 and the negative electrode 42 illustrated in FIG. 3, and corresponds to FIG. 3. FIG. 6 illustrates another planar configuration of the positive electrode 41 illustrated in FIG. 3, and corresponds to FIG. 4. FIG. 7 illustrates a sectional configuration of a main part of the secondary battery illustrated in FIG. 2.

Note that in FIG. 2, for simplifying the illustration, the positive electrode 41, the negative electrode 42, a separator 43, a positive electrode lead 71, and a negative electrode lead 72 are each illustrated in a linear shape, and the illustrations of insulating tapes 50 and 60 are omitted. In FIG. 3, only a portion of the sectional configuration of the battery device 40 is illustrated in an enlarged manner. FIGS. 4 and 6 each illustrate the positive electrode 41 and the negative electrode 42 each in a state before being wound. FIG. 7 illustrates the battery device 40, the insulating tapes 50 and 60, and the positive electrode lead 71, as the main part of the secondary battery.

For convenience, the following description is given with an upper side of each of FIGS. 1 and 2 assumed as an upper side of the secondary battery, and a lower side of each of FIGS. 1 and 2 assumed as a lower side of the secondary battery.

The secondary battery to be described here has such a three-dimensional shape that a height H is smaller than an outer diameter D, as illustrated in FIG. 1. In other words, the secondary battery has a flat and columnar three-dimensional shape. Here, the three-dimensional shape of the secondary battery is flat and cylindrical (circular columnar).

Dimensions of the secondary battery are not particularly limited. However, for example, the outer diameter D is within a range from 3 mm to 30 mm both inclusive, and the height H is within a range from 0.5 mm to 70 mm both inclusive. Note that a ratio of the outer diameter D to the height H, i.e., D/H, is greater than 1. Although not particularly limited, an upper limit of the ratio D/H is preferably less than or equal to 25.

As illustrated in FIGS. 1 to 7, the secondary battery includes an outer package can 10, the battery device 40, and the insulating tape 50. Here, the secondary battery further includes an external terminal 20, a gasket 30, the insulating tape 60, the positive electrode lead 71, and the negative electrode lead 72.

As illustrated in FIGS. 1 and 2, the outer package can 10 is a hollow outer package member to contain components including, without limitation, the battery device 40.

Here, the outer package can 10 has a flat and cylindrical three-dimensional shape corresponding to the three-dimensional shape of the secondary battery which is flat and cylindrical. Accordingly, the outer package can 10 includes two bottom parts M1 and M2 opposed to each other, and a sidewall part M3 lying between the bottom parts M1 and M2. An upper end part of the sidewall part M3 is coupled to the bottom part M1. A lower end part of the sidewall part M3 is coupled to the bottom part M2. As described above, the outer package can 10 is cylindrical. Thus, the bottom parts M1 and M2 are each circular in planar shape, and a surface of the sidewall part M3 is a convexly curved surface.

The outer package can 10 includes a container part 11 and a cover part 12 that are joined to each other. The container part 11 is sealed by the cover part 12. The cover part 12 is welded to the container part 11.

The container part 11 is a container member having a flat and cylindrical shape and containing the battery device 40 and other components inside. The container part 11 has a hollow structure with an upper end part open and a lower end part closed, and thus has an opening 11K at the upper end part.

The cover part 12 is a substantially disk-shaped cover member that closes the opening 11K of the container part 11, and has a through hole 12K. As described above, the cover part 12 is welded to the container part 11 at the opening 11K. The external terminal 20 is attached to the cover part 12, and the cover part 12 thus supports the external terminal 20.

Here, the cover part 12 is so bent as to protrude in part toward the inside of the container part 11. The cover part 12 is thus recessed in part. In this case, a portion of the cover part 12 is so bent as to form a level difference toward a center of the cover part 12. The cover part 12 thus includes a recessed part 12H formed by the cover part 12 being so bent as to protrude in part toward the inside of the container part 11. The through hole 12K is provided at the recessed part 12H.

As described above, the outer package can 10 is a welded can in which two members (the container part 11 and the cover part 12) are welded to each other. As a result, the outer package can 10 after undergoing welding is physically a single member as a whole, and is thus in a state of being not separable into the two members (the container part 11 and the cover part 12) afterward.

The outer package can 10 as a welded can does not include any portion folded over another portion, and does not include any portion in which two or more members lie over each other.

The wording “does not include any portion folded over another portion” means that the outer package can 10 is not so processed as to include a portion folded over another portion. The wording “does not include any portion in which two or more members lie over each other” means that the outer package can 10 after completion of the secondary battery is physically a single member and is thus not separable into two or more members afterward. In other words, the outer package can 10 after being completed is not in a state in which two or more members lie over each other and are assembled to each other in such a manner as to be separable afterward.

In particular, the outer package can 10 as a welded can is a so-called crimpless can, being different from a crimped can which is formed by means of crimping processing. A reason for employing the crimpless can is that this increases a device space volume inside the outer package can 10, and accordingly increases an energy density per unit volume of the secondary battery. The “device space volume” refers to a volume (an effective volume) of an internal space of the outer package can 10 available for containing therein the battery device 40 which is to be involved in charging and discharging reactions.

Here, the outer package can 10 including the container part 11 and the cover part 12 is electrically conductive. The outer package can 10 is coupled to the battery device 40 (the negative electrode 42) via the negative electrode lead 72. The outer package can 10 thus serves as an external coupling terminal for the negative electrode 42. A reason for employing such a configuration is that this makes it unnecessary for the secondary battery to be provided with an external coupling terminal for the negative electrode 42 separate from the outer package can 10, and thus suppresses a decrease in device space volume resulting from providing the external coupling terminal for the negative electrode 42. As a result, the device space volume increases, and accordingly, the energy density per unit volume of the secondary battery increases.

Specifically, the outer package can 10 including the container part 11 and the cover part 12 includes one or more of electrically conductive materials including, without limitation, a metal material and an alloy material. Examples of the electrically conductive materials include iron, copper, nickel, stainless steel, an iron alloy, a copper alloy, and a nickel alloy. Although the stainless steel is not particularly limited in kind, specific examples of the stainless steel include SUS304 stainless steel and SUS316 stainless steel. Note that the container part 11 and the cover part 12 may include the same material, or may include respective different materials.

As will be described later, the outer package can 10 (the cover part 12) is insulated, via the gasket 30, from the external terminal 20 which serves as an external coupling terminal for the positive electrode 41. A reason for this is that contact (a short circuit) between the outer package can 10 (the external coupling terminal for the negative electrode 42) and the external terminal 20 (the external coupling terminal for the positive electrode 41) is prevented.

As illustrated in FIGS. 1 and 2, the external terminal 20 is a coupling terminal to be coupled to electronic equipment when the secondary battery is mounted on the electronic equipment. As described above, the external terminal 20 is attached to the outer package can 10 (the cover part 12), and is thus supported by the cover part 12.

Here, the external terminal 20 is coupled to the battery device 40 (the positive electrode 41) via the positive electrode lead 71. The external terminal 20 thus serves as the external coupling terminal for the positive electrode 41. Accordingly, upon use of the secondary battery, the secondary battery is coupled to electronic equipment via the external terminal 20 (the external coupling terminal for the positive electrode 41) and the outer package can 10 (the external coupling terminal for the negative electrode 42). This allows the electronic equipment to operate with use of the secondary battery as a power source.

The external terminal 20 is a flat and generally plate-shaped member, and is disposed inside the recessed part 12H with the gasket 30 interposed therebetween. The external terminal 20 is thus insulated from the cover part 12 via the gasket 30. Here, the external terminal 20 is placed inside the recessed part 12H so as not to protrude above the cover part 12. A reason for this is that this decreases the height H of the secondary battery and therefore increases the energy density per unit volume of the secondary battery as compared with a case where the external terminal 20 protrudes above the cover part 12.

Note that the external terminal 20 has an outer diameter smaller than an inner diameter of the recessed part 12H. Thus, the external terminal 20 is separated from the cover part 12 surrounding the external terminal 20. Accordingly, the gasket 30 is disposed only partially in a space between the external terminal 20 and the cover part 12 (the recessed part 12H). More specifically, the gasket 30 is disposed only at a location where the external terminal 20 and the cover part 12 would be in contact with each other if it were not for the gasket 30.

The external terminal 20 includes one or more of electrically conductive materials including, without limitation, a metal material and an alloy material. Examples of the electrically conductive materials include aluminum and an aluminum alloy. Note that the external terminal 20 may include a cladding material. The cladding material includes an aluminum layer and a nickel layer that are disposed in order from a side closer to the gasket 30. In the cladding material, the aluminum layer and the nickel layer are roll-bonded to each other.

The gasket 30 is an insulating member disposed between the outer package can 10 (the cover part 12) and the external terminal 20, as illustrated in FIG. 2. The external terminal 20 is fixed to the cover part 12 via the gasket 30. The gasket 30 is ring-shaped in a plan view, and has a through hole at a location corresponding to the through hole 12K. The gasket 30 includes one or more of insulating materials including, without limitation, a polymer compound having an insulating property. Examples of the insulating materials include polypropylene and polyethylene.

A range of placement of the gasket 30 is not particularly limited, and may be chosen as desired. Here, the gasket 30 is disposed in a gap between a top surface of the cover part 12 and a bottom surface of the external terminal 20 inside the recessed part 12H.

The battery device 40 is a power generation device that causes charging and discharging reactions to proceed. As illustrated in FIGS. 2 to 7, the battery device 40 is contained inside the outer package can 10. The battery device 40 includes the positive electrode 41, the negative electrode 42, the separator 43, and an electrolytic solution which is a liquid electrolyte. The electrolytic solution is not illustrated.

The battery device 40 to be described here is a so-called wound electrode body. That is, in the battery device 40, the positive electrode 41 and the negative electrode 42 are stacked on each other with the separator 43 interposed therebetween, and the stack of the positive electrode 41, the negative electrode 42, and the separator 43 is wound. The positive electrode 41 and the negative electrode 42 are opposed to each other with the separator 43 interposed therebetween, and are wound. As a result, a winding center space 40K is present at a center of the battery device 40.

Here, the positive electrode 41, the negative electrode 42, and the separator 43 are wound in such a manner that the separator 43 is disposed in each of an outermost wind and an innermost wind. Respective numbers of winds of the positive electrode 41, the negative electrode 42, and the separator 43 are not particularly limited, and may be chosen as desired.

The battery device 40 has a three-dimensional shape similar to that of the outer package can 10. The battery device 40 thus has a flat and cylindrical three-dimensional shape. A reason for this is that this helps to prevent a so-called dead space (a gap between the outer package can 10 and the battery device 40) from resulting when the battery device 40 is placed inside the outer package can 10, and to thereby allow for efficient use of the internal space of the outer package can 10, as compared with a case where the battery device 40 has a three-dimensional shape different from that of the outer package can 10. As a result, the device space volume increases and accordingly, the energy density per unit volume of the secondary battery increases.

As illustrated in FIGS. 3 to 6, the positive electrode 41 includes a positive electrode current collector 41A and a positive electrode active material layer 41B. In each of FIGS. 4 and 6, the positive electrode active material layer 41B is shaded lightly.

The positive electrode current collector 41A has two opposed surfaces on each of which the positive electrode active material layer 41B is to be provided. The positive electrode current collector 41A includes an electrically conductive material such as a metal material. Examples of the metal material include aluminum.

The positive electrode active material layer 41B is provided on each of the two opposed surfaces of the positive electrode current collector 41A. The positive electrode active material layer 41B includes one or more of positive electrode active materials into which lithium is insertable and from which lithium is extractable. The positive electrode active material layer 41B may further include other materials including, without limitation, a positive electrode binder and a positive electrode conductor. A method of forming the positive electrode active material layer 41B is not particularly limited, and specific examples thereof include a coating method.

As described above, the positive electrode 41 is opposed to the negative electrode 42 with the separator 43 interposed therebetween, and the positive electrode active material layer 41B is provided on each of the two opposed surfaces of the positive electrode current collector 41A. Accordingly, the positive electrode 41 includes the positive electrode active material layer 41B provided on the positive electrode current collector 41A on a side opposed to the negative electrode 42 (the negative electrode active material layer 42B), and the positive electrode active material layer 41B provided on the positive electrode current collector 41A on a side not opposed to the negative electrode 42, that is, a side opposite to the side opposed to the negative electrode 42.

The positive electrode active material includes a lithium compound. The term “lithium compound” is a generic term for a compound that includes lithium as a constituent element. More specifically, the lithium compound is a compound that includes lithium and one or more transition metal elements as constituent elements. A reason for this is that a high energy density is obtainable. Note that the lithium compound may further include one or more of other elements (excluding lithium and transition metal elements). Although not particularly limited in kind, the lithium compound is specifically an oxide, a phosphoric acid compound, a silicic acid compound, or a boric acid compound, for example. Specific examples of the oxide include LiNiO₂, LiCoO₂, and LiMn₂O₄. Specific examples of the phosphoric acid compound include LiFePO₄ and LiMnPO₄.

The positive electrode binder includes one or more of materials including, without limitation, a synthetic rubber and a polymer compound. Examples of the synthetic rubber include a styrene-butadiene-based rubber. Examples of the polymer compound include polyvinylidene difluoride. The positive electrode conductor includes one or more of electrically conductive materials including, without limitation, a carbon material. Examples of the carbon material include graphite, carbon black, acetylene black, and Ketjen black. The electrically conductive material may be a metal material or a polymer compound, for example.

Here, in the positive electrode 41, the positive electrode active material layer 41B is provided on each of the two opposed surfaces of the positive electrode current collector 41A, as illustrated in FIGS. 4 to 6. However, the positive electrode 41 includes an exposed part 41R1 on the side opposed to the negative electrode 42. In the exposed part 41R1, the positive electrode active material layer 41B is not provided on the positive electrode current collector 41A, and the positive electrode current collector 41A is thus exposed. The positive electrode current collector 41A exposed in the exposed part 41R1 is opposed to the negative electrode active material layer 42B. The exposed part 41R1 is provided in the positive electrode 41 in the middle of winding of the positive electrode 41.

Here, the positive electrode 41 further includes an exposed part 41R2 on the side not opposed to the negative electrode 42, i.e., the side opposite to the side opposed to the negative electrode 42. The exposed part 41R2 is located at a position corresponding to the exposed part 41R1. In the exposed part 41R2, the positive electrode active material layer 41B is not provided and thus the positive electrode current collector 41A is exposed. The “position corresponding to the exposed part 41R1” stands for a position overlapping with a portion or all of the exposed part 41R1.

In the positive electrode 41, the positive electrode active material layer 41B is provided on the positive electrode current collector 41A in such a manner as to extend intermittently via the exposed part 41R1. As a result, in a region where the exposed part 41R1 is not provided, the positive electrode active material layer 41B is opposed to the negative electrode active material layer 42B, whereas in a region where the exposed part 41R1 is provided, the positive electrode current collector 41A is opposed to the negative electrode active material layer 42B. Further, in the positive electrode 41, the positive electrode active material layer 41B is provided on the positive electrode current collector 41A in such a manner as to extend intermittently via the exposed part 41R2.

Here, the positive electrode 41 has an “intermittent direction U1” (a first direction) and an “intersecting direction U2” (a second direction). The intermittent direction U1 is a direction along which the positive electrode active material layer 41B is provided intermittently via the exposed part 41R1, and is a horizontal direction in FIG. 4. The intersecting direction U2 is a direction intersecting the intermittent direction U1, and is a vertical direction in FIG. 4.

In this case, the positive electrode active material layer 41B includes two portions, i.e., portions P1 and P2 that are separate from each other with the exposed part 41R1 interposed therebetween. The portion P1 is a first portion located on one side in the intermittent direction U1, i.e., a right side in FIG. 4, relative to the exposed part 41R1. The portion P2 is a second portion located on another side in the intermittent direction U1, i.e., a left side in FIG. 4, relative to the exposed part 41R1.

As illustrated in FIGS. 3 to 5, the negative electrode 42 includes a negative electrode current collector 42A and a negative electrode active material layer 42B. In FIG. 4, the negative electrode active material layer 42B is shaded lightly.

The negative electrode current collector 42A has two opposed surfaces on each of which the negative electrode active material layer 42B is to be provided. The negative electrode current collector 42A includes an electrically conductive material such as a metal material. Examples of the metal material include copper.

The negative electrode active material layer 42B is provided on each of the two opposed surfaces of the negative electrode current collector 42A. The negative electrode active material layer 42B includes one or more of negative electrode active materials into which lithium is insertable and from which lithium is extractable. The negative electrode active material layer 42B may further include other materials including, without limitation, a negative electrode binder and a negative electrode conductor. Details of the negative electrode binder are similar to those of the positive electrode binder. Details of the negative electrode conductor are similar to those of the positive electrode conductor. A method of forming the negative electrode active material layer 42B is not particularly limited, and specifically includes one or more of methods including, without limitation, a coating method, a vapor-phase method, a liquid-phase method, a thermal spraying method, and a firing (sintering) method.

As described above, the negative electrode 42 is opposed to the positive electrode 41 with the separator 43 interposed therebetween, and the negative electrode active material layer 42B is provided on each of the two opposed surfaces of the negative electrode current collector 42A. Accordingly, the negative electrode 42 includes the negative electrode active material layer 42B provided on the negative electrode current collector 42A on a side opposed to the positive electrode 41 (the positive electrode active material layer 41B), and the negative electrode active material layer 42B provided on the negative electrode current collector 42A on a side not opposed to the positive electrode 41, that is, a side opposite to the side opposed to the positive electrode 41.

The negative electrode active material includes a carbon material, a metal-based material, or both. A reason for this is that a high energy density is obtainable. Examples of the carbon material include graphitizable carbon, non-graphitizable carbon, and graphite (natural graphite and artificial graphite). The metal-based material is a material that includes, as a constituent element or constituent elements, one or more elements among metal elements and metalloid elements that are each able to form an alloy with lithium. Examples of such metal elements and metalloid elements include silicon, tin, or both. The metal-based material may be a simple substance, an alloy, a compound, a mixture of two or more thereof, or a material including two or more phases thereof. Specific examples of the metal-based material include TiSi₂ and SiOₓ (0 < x ≤ 2 or 0.2 < x < 1.4).

Here, in the negative electrode 42, the negative electrode active material layer 42B is provided on each of the two opposed surfaces of the negative electrode current collector 42A, as illustrated in FIGS. 4 and 5. Note that the negative electrode 42 includes an exposed part 42R1 on the side opposed to the positive electrode 41, and an exposed part 42R2 on the side not opposed to the positive electrode 41, i.e., the side opposite to the side opposed to the positive electrode 41. In each of the exposed parts 42R1 and 42R2, the negative electrode active material layer 42B is not provided on the negative electrode current collector 42A, and the negative electrode current collector 42A is thus exposed. The exposed part 42R1 is provided in the negative electrode 42 at each of an outermost wind and an innermost wind of the negative electrode 42. The exposed part 42R2 is provided in the negative electrode 42 at each of the outermost wind and the innermost wind of the negative electrode 42.

In the negative electrode 42, the negative electrode active material layer 42B is provided continuously on the negative electrode current collector 42A, unlike in the positive electrode 41 in which the positive electrode active material layer 41B is provided intermittently via the exposed part 41R1 (or the exposed part 41R2) on the positive electrode current collector 41A.

Note that a range of formation of the negative electrode active material layer 42B is extended relative to a range of formation of the positive electrode active material layer 41B toward opposite sides in the intermittent direction U1. That is, the range of formation of the negative electrode active material layer 42B is extended relative to the range of formation of the positive electrode active material layer 41B on one of the opposite sides in the intermittent direction U1, i.e., the right side in FIG. 4, and is extended relative to the range of formation of the positive electrode active material layer 41B also on the other of the opposite sides in the intermittent direction U1, i.e., the left side in FIG. 4. This is for the purpose of preventing precipitation of lithium extracted from the positive electrode active material layer 41B.

The negative electrode 42 protrudes relative to the positive electrode 41 toward opposite sides in the intersecting direction U2. That is, the negative electrode 42 protrudes relative to the positive electrode 41 on one of the opposite sides in the intersecting direction U2, i.e., an upper side in FIG. 4, and protrudes relative to the positive electrode 41 also on the other of the opposite sides in the intersecting direction U2, i.e., a lower side in FIG. 4. This is for the purpose of preventing precipitation of lithium extracted from the positive electrode active material layer 41B.

The separator 43 is an insulating porous film interposed between the positive electrode 41 and the negative electrode 42 as illustrated in FIGS. 2, 3, and 7. The separator 43 allows lithium ions to pass therethrough while preventing a short circuit between the positive electrode 41 and the negative electrode 42. The separator 43 includes a polymer compound such as polyethylene.

Here, the separator 43 protrudes relative to the negative electrode 42 toward the opposite sides in the intersecting direction U2. That is, the separator 43 protrudes relative to the negative electrode 42 on one of the opposite sides in the intersecting direction U2, i.e., the upper side in FIG. 7, and protrudes relative to the negative electrode 42 also on the other of the opposite sides in the intersecting direction U2, i.e., the lower side in FIG. 7.

The separator 43 includes an upper end part 43M and a lower end part 43N in the intersecting direction U2. The upper end part 43M is an end part of the separator 43 on the upper side in the intersecting direction U2. The lower end part 43N is an end part of the separator 43 on the lower side in the intersecting direction U2.

The upper end part 43M is extended horizontally relative to parts other than the upper end part 43M, excluding the lower end part 43N. That is, the upper end part 43M is extended toward one side, i.e., the right side in FIG. 7, relative to the negative electrode 42, and is extended toward another side, i.e., the left side in FIG. 7, relative to the negative electrode 42. As a result, the upper end part 43M extends to above the negative electrode 41 and thus shields an upper end part of the negative electrode 42 from the outer package can 10 (the cover part 12).

The lower end part 43N has a configuration similar to that of the upper end part 43M. That is, the lower end part 43N is extended horizontally relative to parts other than the lower end part 43N, excluding the upper end part 43M. Thus, the lower end part 43N is extended toward the one side, i.e., the right side in FIG. 7, relative to the positive electrode 41, and is extended toward the other side, i.e., the left side in FIG. 7, relative to the positive electrode 41. The lower end part 43N extends to below the positive electrode 41. As a result, the lower end part 43N shields a lower end part of the positive electrode 41 from the outer package can 10 (the container part 11).

More specifically, as will be described later, in a process of manufacturing the secondary battery, a wound body 40Z is fabricated and thereafter, the upper end part 43M and the lower end part 43N of the separator 43 wound in the wound body 40Z each undergo a heat treatment. Although a heating temperature during the heat treatment may be chosen as desired, a specific example of the heating temperature is 100° C. or higher. The heat treatment causes each of the upper end part 43M and the lower end part 43N to undergo thermal deformation or thermal contraction. As a result, the upper end part 43M and the lower end part 43N are extended horizontally in such a manner as to shield an upper end part and the lower end part of the positive electrode 41, respectively.

In this case, because the positive electrode 41 and the separator 43 are each wound, the positive electrode 41 is sealed by the separator 43 (the upper end part 43M and the lower end part 43N). That is, the respective upper end parts 43M of mutually adjacent separators 43 are extended horizontally to come into contact with each other, and as a result, the upper end part of the positive electrode 41 is confined by those upper end parts 43M. Further, the respective lower end parts 43N of mutually adjacent separators 43 are extended horizontally to come into contact with each other, and as a result, the lower end part of the positive electrode 41 is confined by those lower end parts 43N. A reason for employing such a configuration is that it helps to prevent each of the upper end part and the lower end part of the positive electrode 41 from being exposed easily, and thereby suppresses a short circuit between the positive electrode 41 and the outer package can 10 (the container part 11 and the cover part 12).

Note that the upper end part 43M shields not only the upper end part of the positive electrode 41 but also the upper end part of the negative electrode 42. Further, the lower end part 43N shields not only the lower end part of the positive electrode 41 but also the lower end part of the negative electrode 42.

Here, both the upper end part 43M and the lower end part 43N are extended horizontally by making use of the heat treatment (thermal deformation or thermal contraction). However, only either the upper end part 43M or the lower end part 43N may be extended horizontally by making use of the heat treatment. In such cases also, a short circuit between the positive electrode 41 and the outer package can 10 is suppressed, unlike in a case where neither the upper end part 43M nor the lower end part 43N is extended horizontally. Note that a treatment for causing each of the upper end part 43M and the lower end part 43N to be extended horizontally is not limited to the heat treatment, and may be another treatment such as pressing.

The electrolytic solution includes a solvent and an electrolyte salt. The positive electrode 41, the negative electrode 42, and the separator 43 are each impregnated with the electrolytic solution. The solvent includes one or more of non-aqueous solvents (organic solvents) including, without limitation, a carbonic-acid-ester-based compound, a carboxylic-acid-ester-based compound, and a lactone-based compound. An electrolytic solution including any of the non-aqueous solvents is a so-called non-aqueous electrolytic solution. The electrolyte salt includes one or more of light metal salts including, without limitation, a lithium salt.

The insulating tape 50 is an insulating member that prevents a short circuit between the positive electrode 41 (the positive electrode current collector 41A) and the negative electrode 42 from occurring at the exposed part 41R1. As illustrated in FIGS. 4 to 7, the insulating tape 50 is provided on the positive electrode 41. In FIG. 4, the insulating tape 50 is shaded darkly relative to the positive electrode active material layer 41B.

The insulating tape 50 exposes at least the exposed part 41R1. Accordingly, the insulating tape 50 may cover only the positive electrode current collector 41A exposed in the exposed part 41R1, or may cover also the positive electrode active material layer 41B together with the positive electrode current collector 41A exposed. In the latter case, the insulating tape 50 may overlie only the portion P1, only the portion P2, or both of the portions P1 and P2.

In particular, the insulating tape 50 preferably overlies both of the portions P1 and P2. This is for the purpose of helping to prevent the positive electrode current collector 41A from being unintentionally exposed in the exposed part 41R1 by failing to be covered by the insulating tape 50 due to any of factors including, without limitation, a dimensional tolerance and a placement error of the insulating tape 50.

Further, the insulating tape 50 protrudes relative to the positive electrode 41 toward the opposite sides in the intersecting direction U2. That is, the insulating tape 50 protrudes relative to the positive electrode 41 on one of the opposite sides in the intersecting direction U2, i.e., the upper side in FIG. 4, and protrudes relative to the positive electrode 41 also on the other of the opposite sides in the intersecting direction U2, i.e., the lower side in FIG. 4. This is for the purpose of helping to prevent the positive electrode current collector 41A from being unintentionally exposed in the exposed part 41R1 by failing to be covered by the insulating tape 50 due to any of factors including, without limitation, a dimensional tolerance and a placement error of the insulating tape 50.

Here, the insulating tape 50 further protrudes relative to the separator 43 toward the opposite sides in the intersecting direction U2. That is, the insulating tape 50 protrudes relative to the separator 43 on one of the opposite sides in the intersecting direction U2, i.e., the upper side in FIG. 7, and protrudes relative to the separator 43 also on the other of the opposite sides in the intersecting direction U2, i.e., the lower side in FIG. 7. This is for the purpose of helping to prevent a short circuit between the positive electrode 41 and the outer package can 10 (the container part 11 and the cover part 12) from occurring due to any of factors including, without limitation, a dimensional tolerance and a placement error of the separator 43.

Note that a configuration of the insulating tape 50 is not particularly limited. Here, the insulating tape 50 has a structure in which a base layer and an adhesive layer are stacked on each other. The base layer includes a polymer compound such as polyethylene terephthalate (PET). The adhesive layer includes a rubber-based adhesive. In the insulating tape 50, the base layer is attached to the positive electrode 41 via the adhesive layer.

The insulating tape 60 is another insulating member that prevents a short circuit between the positive electrode lead 71 and another electrically conductive member. As illustrated in FIGS. 4, 6, and 7, the insulating tape 60 is provided on the positive electrode lead 71. The other electrically conductive member is not particularly limited in kind, and specific examples thereof include the outer package can 10 (the cover part 12). In each of FIGS. 4 and 6, the insulating tape 60 is shaded darkly relative to the positive electrode active material layer 41B.

The insulating tape 60 covers a portion of the positive electrode lead 71 protruding from the positive electrode 41 on a side of the positive electrode lead 71 opposed to the negative electrode 42, and is so disposed as to be sandwiched between the positive electrode lead 71 and the insulating tape 50. In this case, a range of placement of the insulating tape 60 is not particularly limited. Accordingly, the insulating tape 60 may or may not overlap in part with the insulating tape 50. That is, an overlap distance S of the insulating tape 60 with the insulating tape 50 may be chosen as desired.

In particular, the insulating tape 60 preferably overlaps in part with the insulating tape 50. This is for the purpose of helping to prevent the positive electrode lead 71 from being unintentionally exposed by failing to be covered by the insulating tape 60 due to any of factors including, without limitation, a dimensional tolerance and a placement error of the insulating tape 60. In this case, a range of overlap between the insulating tapes 50 and 60 is not particularly limited. Accordingly, the insulating tape 60 may or may not overlap with the positive electrode current collector 41A at the exposed part 41R1.

In particular, the insulating tape 60 preferably does not overlap with the positive electrode current collector 41A. A reason for this is that such a configuration suppresses an increase in outer diameter of the battery device 40 resulting from an overlap of the insulating tape 60 with the positive electrode current collector 41A, and thus allows for securing of the energy density per unit volume of the secondary battery.

Note that the insulating tape 60 has a configuration similar to that of the insulating tape 50. In the insulating tape 60, a base layer is attached to the positive electrode lead 71 via an adhesive layer.

The positive electrode lead 71 is a wiring member coupled to the positive electrode current collector 41A at the exposed part 41R2. The positive electrode lead 71 protrudes relative to the positive electrode current collector 41A in the intersecting direction U2. Here, the positive electrode lead 71 protrudes toward one side in the intersecting direction U2, i.e., the upper side in FIG. 4.

Details of a material included in the positive electrode lead 71 are similar to the details of the material included in the positive electrode current collector 41A. Note that the material included in the positive electrode lead 71 and the material included in the positive electrode current collector 41A may be the same as or different from each other.

A position of coupling of the positive electrode lead 71 to the positive electrode 41 (the positive electrode current collector 41A) is not particularly limited. That is, the positive electrode lead 71 may be coupled to the positive electrode 41 at an outermost wind or an innermost wind of the positive electrode 41, or may be coupled to the positive electrode 41 in the middle of the winding of the positive electrode 41.

In particular, the positive electrode lead 71 is preferably coupled to the positive electrode 41 on an inner side of the winding of the positive electrode 41 relative to the outermost wind of the positive electrode 41. A reason for this is that such a configuration suppresses a corrosion of the outer package can 10 resulting from creeping up of the electrolytic solution. The “creeping up of the electrolytic solution” refers to a phenomenon in which, in a case where the positive electrode lead 71 is disposed in proximity to an inner wall surface of the outer package can 10, the electrolytic solution in the battery device 40 creeps up along the positive electrode lead 71 to reach the inner wall surface of the outer package can 10, and the outer package can 10 dissolves or changes in color due to contact with the electrolytic solution.

Here, the positive electrode lead 71 is disposed in the middle of the winding of the positive electrode 41, and the through hole 12K is provided in the recessed part 12H of the cover part 12. As a result, a portion of the positive electrode lead 71 (the portion protruding relative the positive electrode 41) is so bent as to be along an upper end part of the battery device 40. In this case, the portion of the positive electrode lead 71 digs into a portion of the separator 43, i.e., the upper end part 43M, that shields the positive electrode 41.

That is, as described above, the upper end part 43M of the separator 43 shields the upper end part of the positive electrode 41. In this case, in the process of manufacturing the secondary battery, as will be described later, when the positive electrode lead 71 is bent after the fabrication of the wound body 40Z with the positive electrode lead 71 attached thereto, the positive electrode lead 71 is pressed against the upper end part 43M. In this case, the positive electrode lead 71 may be pressed against the separator 43 while the separator 43 is heat-treated. The upper end part 43M is thereby deformed to be recessed as a result of pressing by the positive electrode lead 71. Accordingly, the positive electrode lead 71 digs into the upper end part 43M. More specifically, the positive electrode lead 71 is disposed in part inside a recessed part 43H that is formed in the upper end part 43M due to the pressing by the positive electrode lead 71. The positive electrode lead 71 is thus held in part by the upper end part 43M through the use of the recessed part 43H. In this case, if the separator 43 is heat-treated, it becomes easier for the separator 43 to undergo thermal deformation, and accordingly, it becomes easier for the positive electrode lead 71 to dig into the upper end part 43M.

A reason for employing such a configuration is that it allows the positive electrode lead 71 to be firmly fixed to the battery device 40 by making use of digging of the positive electrode lead 71 into the upper end part 43M, and thus helps to prevent the positive electrode lead 71 from being damaged easily. Examples of damage to the positive electrode lead 71 include cracking of the positive electrode lead 71, breaking of the positive electrode lead 71, and falling-off of the positive electrode lead 71 from the positive electrode 41.

Note that the positive electrode lead 71 is physically separate from the positive electrode current collector 41A and is thus provided separately from the positive electrode current collector 41A. Alternatively, the positive electrode lead 71 may be physically continuous with the positive electrode current collector 41A and may thus be provided integrally with the positive electrode current collector 41A.

The negative electrode lead 72 is coupled to the negative electrode current collector 42A at the exposed part 42R2, and protrudes relative to the negative electrode current collector 42A in the intersecting direction U2. Here, the negative electrode lead 72 protrudes toward the other side in the intersecting direction U2, i.e., the lower side in FIG. 4.

Details of a material included in the negative electrode lead 72 are similar to the details of the material included in the negative electrode current collector 42A. Note that the material included in the negative electrode lead 72 and the material included in the negative electrode current collector 42A may be the same as or different from each other. A position of coupling of the negative electrode lead 72 to the negative electrode 42 (the negative electrode current collector 42A) is not particularly limited, and may be chosen as desired. Here, the negative electrode lead 72 is coupled to a bottom surface of the container part 11, i.e., the bottom part M2.

Note that the negative electrode lead 72 is physically separate from the negative electrode current collector 42A and is thus provided separately from the negative electrode current collector 42A. Alternatively, the negative electrode lead 72 may be physically continuous with the negative electrode current collector 42A and may thus be provided integrally with the negative electrode current collector 42A.

Note that the secondary battery may further include one or more of other unillustrated components.

For example, the secondary battery includes a safety valve mechanism. The safety valve mechanism cuts off electrical coupling between the outer package can 10 and the battery device 40 (the negative electrode 42) if an internal pressure of the outer package can 10 reaches a certain level or higher. Examples of a factor that causes the internal pressure of the outer package can 10 to reach the certain level or higher include the occurrence of a short circuit in the secondary battery and heating of the secondary battery from outside. A placement location of the safety valve mechanism is not particularly limited. However, the safety valve mechanism is preferably placed on either the bottom part M1 or the bottom part M2, more preferably, on the bottom part M2 to which no external terminal 20 is attached.

Further, the secondary battery includes an insulator between the outer package can 10 and the battery device 40. The insulator includes one or more of materials including, without limitation, an insulating film and an insulating sheet, and prevents a short circuit between the outer package can 10 and the battery device 40 (the positive electrode 41). A range of placement of the insulator is not particularly limited, and may be chosen as desired.

Note that the outer package can 10 is provided with a cleavage valve. The cleavage valve cleaves to release the internal pressure of the outer package can 10 in a case where the internal pressure reaches a certain level or higher. A placement location of the cleavage valve is not particularly limited. However, the cleavage valve is preferably placed on either the bottom part M1 or the bottom part M2, more preferably, on the bottom part M2, as with the placement location of the safety valve mechanism described above.

In the secondary battery, a dimensional condition described below is satisfied in order to improve each of operational reliability and manufacturing stability. In the following description, a dimension in the intermittent direction U1 is defined as a “length”, and a dimension in the intersecting direction U2 is defined as a “width”. For describing the dimensional condition, a series of figures described already will be referred to where appropriate.

Specifically, the positive electrode 41 has a length L1 and a width W1, and the negative electrode 42 has a length L2 and a width W2. As described above, the negative electrode 42 protrudes relative to the positive electrode 41 toward the opposite sides in the intersecting direction U2, and therefore the width W2 of the negative electrode 42 is greater than the width W1 of the positive electrode 41. Note that the length L2 of the negative electrode 42 is greater than the length L1 of the positive electrode 41.

The insulating tape 50 has a width W5. As described above, the insulating tape 50 protrudes relative to the positive electrode 41 toward the opposite sides in the intersecting direction U2, and therefore the width W5 of the insulating tape 50 is greater than the width W1 of the positive electrode 41.

A portion of the insulating tape 50 protruding toward the upper side relative to the positive electrode 41 has a width W3, and a portion of the insulating tape 50 protruding toward the lower side relative to the positive electrode 41 has a width W4.

In this case, the width W1 of the positive electrode 41, the width W2 of the negative electrode 42, and the widths W3 and W4 of the protruding portions of the insulating tape 50 satisfy a relationship represented by Expression (1) below. In the following description, (W3 + W4)/(W2 - W1) representing the relationship between the widths W1 to W4 will be referred to as a “width ratio”.

$$0.50 \leq \left(\text{W3+W4}\right) / \left(\text{W2-W1}\right) \leq 3.00$$

where:
W1 is the dimension of the positive electrode 41 in the intersecting direction U2;
W2 is the dimension of the negative electrode 42 in the intersecting direction U2;
W3 is the dimension of protrusion of the insulating tape 50 relative to the positive electrode 41 on one of the opposite sides, i.e., the upper side, in the intersecting direction U2; and
W4 is the dimension of protrusion of the insulating tape 50 relative to the positive electrode 41 on the other of the opposite sides, i.e., the lower side, in the intersecting direction U2.

A reason why the relationship represented by Expression (1) is satisfied regarding the dimensional condition (the width ratio (W3 +W4)/(W2 - W1)) for the secondary battery is that the widths W1 to W4 are made appropriate with respect to each other. This allows the secondary battery including the outer package can 10 (the container part 11 and the cover part 12) to be manufactured stably while suppressing a short circuit between the battery device 40 (the positive electrode 41) and the outer package can 10 (the container part 11 and the cover part 12). A description will be given later as to details of the reason described here.

In particular, the width ratio (W3 + W4)/(W2 - W1) preferably satisfies a relationship represented by Expression (2) below. A reason for this is that the secondary battery including the outer package can 10 is manufactured more stably while a short circuit between the battery device 40 and the outer package can 10 is prevented further.

$$2.00 \leq \left(\text{W3+W4}\right) / \left(\text{W2} - \text{W1}\right) \leq 2.75$$

Note that the separator 43 has a width W6. As described above, the separator 43 protrudes relative to the positive electrode 41 toward the opposite sides in the intersecting direction U2. The width W6 of the separator 43 is therefore greater than the width W1 of the positive electrode 41.

In this case, as described above, the insulating tape 50 protrudes relative to the separator 43 toward the opposite sides in the intersecting direction U2. The width W5 of the insulating tape 50 is therefore greater than the width W6 of the separator 43.

Upon charging of the secondary battery, in the battery device 40, lithium is extracted from the positive electrode 41, and the extracted lithium is inserted into the negative electrode 42 via the electrolytic solution. Upon discharging of the secondary battery, in the battery device 40, lithium is extracted from the negative electrode 42, and the extracted lithium is inserted into the positive electrode 41 via the electrolytic solution. Upon the charging and the discharging, lithium is inserted and extracted in an ionic state.

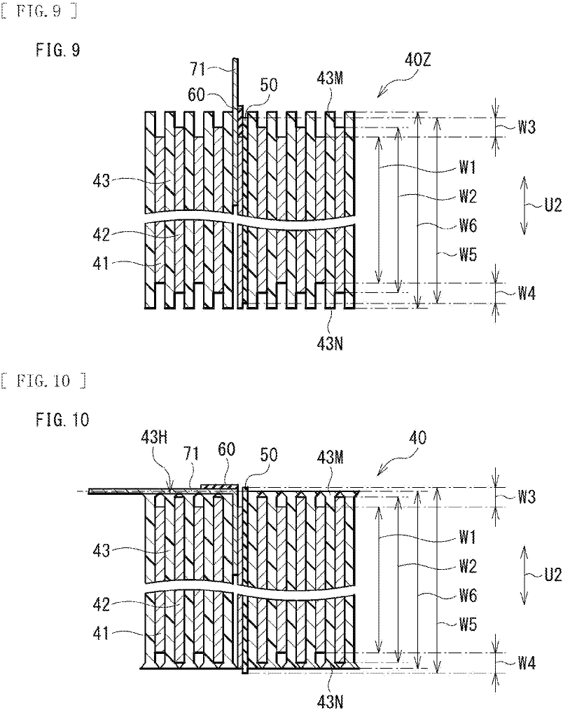

FIG. 8 illustrates a perspective configuration of the outer package can 10 to be used in the process of manufacturing the secondary battery, and corresponds to FIG. 1. To describe the process of manufacturing the secondary battery, FIG. 9 illustrates a sectional configuration corresponding to FIG. 7. Note that FIG. 8 illustrates a state where the cover part 12 is yet to be welded to the container part 11 and is thus separate from the container part 11. FIG. 9 illustrates a state where the positive electrode lead 71 is yet to be bent and thus extends substantially linearly.

In the following description, where appropriate, FIGS. 1 to 7 described already will be referred to in conjunction with FIGS. 8 and 9.

Here, as illustrated in FIG. 8, the container part 11 and the cover part 12 that are physically separate from each other are used to form the outer package can 10. The container part 11 is a member in which the bottom part M2 and the sidewall part M3 are integrated with each other, and has the opening 11K, as described above. To the recessed part 12H provided in the cover part 12, the external terminal 20 is attached in advance via the gasket 30.

Alternatively, the bottom part M2 and the sidewall part M3 may be physically separate from each other, and the container part 11 may thus be formed by welding the sidewall part M3 to the bottom part M2.

First, the positive electrode active material is mixed with other materials including, without limitation, the positive electrode binder and the positive electrode conductor to thereby obtain a positive electrode mixture. Thereafter, the positive electrode mixture is put into a solvent such as an organic solvent to thereby prepare a paste positive electrode mixture slurry.

Thereafter, the positive electrode mixture slurry is applied on the two opposed surfaces of the positive electrode current collector 41A to thereby form the positive electrode active material layers 41B. In this case, the range of formation of the positive electrode active material layers 41B is adjusted in such a manner that the exposed parts 41R1 and 41R2 are each disposed in the middle of the winding in a process of fabricating the wound body 40Z to be described later, that is, upon winding the positive electrode 41.

Lastly, the positive electrode active material layers 41B are compression-molded by means of, for example, a roll pressing machine. In this case, the positive electrode active material layers 41B may be heated. The positive electrode active material layers 41B may be compression-molded multiple times. In this manner, the positive electrode 41 having the length L1 and the width W1 and including the exposed parts 41R1 and 41R2 is fabricated.

First, the negative electrode active material is mixed with other materials including, without limitation, the negative electrode binder and the negative electrode conductor to thereby obtain a negative electrode mixture. Thereafter, the negative electrode mixture is put into a solvent such as an organic solvent to thereby prepare a paste negative electrode mixture slurry.

Thereafter, the negative electrode mixture slurry is applied on the two opposed surfaces of the negative electrode current collector 42A to thereby form the negative electrode active material layers 42B. In this case, the range of formation of the negative electrode active material layers 42B is adjusted in such a manner that the exposed parts 42R1 and 42R2 are disposed at each of the outermost wind and the innermost wind in the process of fabricating the wound body 40Z to be described later, that is, upon winding the negative electrode 42.

Lastly, the negative electrode active material layers 42B are compression-molded by means of, for example, a roll pressing machine. Details of the compression molding of the negative electrode active material layers 42B are similar to the details of the compression molding of the positive electrode active material layers 41B. In this manner, the negative electrode 42 having the length L2 and the width W2 and including the exposed parts 42R1 and 42R2 is fabricated.

The electrolyte salt is put into the solvent. The electrolyte salt is thereby dispersed or dissolved in the solvent. Thus, the electrolytic solution is prepared.

First, by means of a method such as a welding method, the positive electrode lead 71 is coupled to the positive electrode 41 (the positive electrode current collector 41A) at the exposed part 41R2, and the negative electrode lead 72 is coupled to the negative electrode 42 (the negative electrode current collector 42A) at the exposed part 42R2. Although not particularly limited in kind, the welding method includes one or more of methods including, without limitation, a resistance welding method, an ultrasonic welding method, and a laser welding method. Details of the welding method described here apply also to the following.

Thereafter, the insulating tape 60 is attached to the positive electrode lead 71. Thereafter, the insulating tape 50 having the width W5 is attached to the positive electrode current collector 41A exposed in the exposed part 41R1. In this case, an attachment position of the insulating tape 50 is adjusted in such a manner that the insulating tape 50 protrudes relative to the positive electrode 41 toward the opposite sides in the intersecting direction U2 to have the widths W3 and W4 and that the insulating tape 50 overlaps in part with the insulating tape 60.

Thereafter, the positive electrode 41 with the positive electrode lead 71 coupled thereto and with the insulating tapes 50 and 60 attached thereto, and the negative electrode 42 with the negative electrode lead 72 coupled thereto are stacked on each other with the separator 43 having the width W6 interposed therebetween, following which the stack of the positive electrode 41, the negative electrode 42, and the separator 43 is wound to thereby fabricate the wound body 40Z as illustrated in FIG. 8. The wound body 40Z has a configuration similar to that of the battery device 40 except that the positive electrode 41, the negative electrode 42, and the separator 43 are each unimpregnated with the electrolytic solution. In a state where the wound body 40Z has been fabricated, the width W6 of the separator 43 is greater than the width W5 of the insulating tape 50, as illustrated in FIG. 9.

Thereafter, the positive electrode lead 71 with the insulating tape 60 attached thereto is bent while the upper end part 43M and the lower end part 43N of the separator 43 are each heat-treated. This causes, as illustrated in FIG. 7, each of the upper end part 43M and the lower end part 43N to be extended horizontally due to thermal deformation or thermal contraction, thus allowing each of the upper end part and the lower end part of the positive electrode 41 to be shielded by the separator 43 (the upper end part 43M and the lower end part 43N). This further causes the positive electrode lead 71 to be pressed against the upper end part 43M while the separator 43 (the upper end part 43M) is heated. As a result, the positive electrode lead 71 digs into the separator 43 (the upper end part 43M) via the recessed part 43H.

Thereafter, the wound body 40Z with the positive electrode lead 71 and the negative electrode lead 72 each coupled thereto is placed into the container part 11 through the opening 11K. In this case, the negative electrode lead 72 is coupled to the container part 11 by means of a method such as a welding method.

Thereafter, with use of the cover part 12 to which the external terminal 20 is attached via the gasket 30, the positive electrode lead 71 is coupled to the external terminal 20 via the through hole 12K by means of a method such as a welding method.

Thereafter, the electrolytic solution is injected into the container part 11 through the opening 11K. The wound body 40Z (including the positive electrode 41, the negative electrode 42, and the separator 43) is thereby impregnated with the electrolytic solution. Thus, the battery device 40 which is the wound electrode body is fabricated.

Thereafter, the opening 11K is shielded with the cover part 12, following which the cover part 12 is welded to the container part 11 by means of a method such as a welding method. The container part 11 and the cover part 12 are thereby joined to each other. In this manner, the outer package can 10 is formed, and the components including, without limitation, the battery device 40 and the insulating tape 50 are contained inside the outer package can 10. The secondary battery is thus assembled.

The secondary battery after being assembled is charged and discharged. Various conditions including, for example, an environment temperature, the number of times of charging and discharging (the number of cycles), and charging and discharging conditions, may be chosen as desired. As a result, a film is formed on a surface of, for example, the negative electrode 42. This brings the secondary battery into an electrochemically stable state. The secondary battery is thus completed.

According to the secondary battery, the condition represented by Expression (1), that is, 0.50 ≤ (W3 + W4)/(W2 - W1) ≤ 3.00, is satisfied regarding the width ratio (W3 + W4)/(W2 - W1) representing the relationship between the width W1 of the positive electrode 41, the width W2 of the negative electrode 42, and the widths W3 and W4 of the insulating tape 50.

In this case, the widths W4 and W5 are made appropriate in relation to the widths W1 and W2, and accordingly, the widths W1 to W4 are made appropriate with respect to each other.

As a result, the insulating tape 50 protrudes sufficiently relative to the positive electrode 41 toward the opposite sides in the intersecting direction U2, which allows the positive electrode 41 to be sufficiently separated away from the outer package can 10 (the container part 11 and the cover part 12) via the insulating tape 50. The positive electrode 41 is thus prevented from easily coming into contact with the outer package can 10 which serves as the external coupling terminal for the negative electrode 42. That is, the positive electrode 41 is substantially prevented from easily coming into contact with the negative electrode 42. Accordingly, a short circuit between the battery device 40 (the positive electrode 41) and the outer package can 10 is suppressed.

Moreover, the insulating tape 50 does not excessively protrude relative to the positive electrode 41 toward the opposite sides in the intersecting direction U2. This prevents the insulating tape 50 from interfering with a joining process to be performed in joining the cover part 12 to the container part 11 for closing the opening 11K. Accordingly, the opening 11K of the container part 11 is sufficiently closed by the cover part 12, and the container part 11 is thus sealed by the cover part 12. As a result, the outer package can 10 is stably formed with use of the container part 11 and the cover part 12, and the secondary battery including the outer package can 10 is thus stably manufactured.

By virtue of the foregoing, the secondary battery (the outer package can 10 including the container part 11 and the cover part 12) is stably manufactured even if the insulating tape 50 is included, while a short circuit between the battery device 40 (the positive electrode 41) and the outer package can 10 is suppressed with use of the insulating tape 50. Accordingly, it is possible to achieve high operational reliability and superior manufacturing stability.

In particular, the condition represented by Expression (2) may be satisfied regarding the width ratio (W3 + W4)/(W2 - W1). This allows further suppression of the short circuit, and allows the secondary battery to be manufactured more stably. Accordingly, it is possible to achieve higher effects.

Further, the insulating tape 50 may overlie one or both of the portions P1 and P2 of the positive electrode active material layer 41B. This helps to prevent the positive electrode current collector 41A from being unintentionally exposed in the exposed part 41R1 by failing to be covered by the insulating tape 50. The short circuit is thus suppressed further. Accordingly, it is possible to achieve higher effects.

Further, the insulating tape 60 may be provided on the positive electrode lead 71, and the insulating tape 60 may overlap in part with the insulating tape 50. In such a case, a short circuit caused by the positive electrode lead 71 is also suppressed for a reason described below. Accordingly, it is possible to achieve higher effects.

FIG. 10 illustrates a sectional configuration of a main part of a secondary battery according to a first reference example, and corresponds to FIG. 7. The secondary battery according to the first reference example has a configuration similar to that of the secondary battery according to the present embodiment (FIG. 7) except that the insulating tape 60 is provided on the positive electrode lead 71 in such a manner as not to overlap in part with the insulating tape 50.

In the secondary battery according to the first reference example, as illustrated in FIG. 10, no portion of the insulating tape 60 overlaps with the insulating tape 50. In this case, upon bending of the positive electrode lead 71, a portion of the positive electrode lead 71 can fail to be covered by the insulating tape 60 and can thus be exposed due to a factor such as a dimensional tolerance or a placement error of the insulating tape 60, if any. As a result, a short circuit between the positive electrode lead 71 and the outer package can 10 (the cover part 12) can occur.

In contrast, in the secondary battery according to an embodiment, as illustrated in FIG. 7, the insulating tape 60 overlaps in part with the insulating tape 50. In this case, even in the presence of or upon the occurrence of, for example, a dimensional tolerance or a placement error of the insulating tape 60, the positive electrode lead 71 is prevented from being easily exposed in part upon bending of the positive electrode lead 71, as along as the insulating tape 60 remains in a state of overlapping in part with the insulating tape 50. This prevents a short circuit between the positive electrode lead 71 and the outer package can 10 (the cover part 12) from occurring easily. As a result, not only a short circuit arising from the positive electrode 41 but also a short circuit arising from the positive electrode lead 71 is suppressed. Accordingly, it is possible to achieve higher effects.

In this case, the insulating tape 60 may not overlap with the positive electrode 41. This suppresses an increase in outer diameter of the battery device 40. As a result, the energy density per unit volume of the secondary battery increases. Accordingly, it is possible to achieve higher effects.

Further, the separator 43 may protrude relative to the positive electrode 41 toward the opposite sides in the intersecting direction U2, and the insulating tape 50 may protrude relative to the separator 43 toward the opposite sides in the intersecting direction U2. This allows the positive electrode 41 to be separated away from the outer package can 10 (the container part 11 and the cover part 12) via the separator 43 and the insulating tape 50. Thus, a short circuit between the battery device 40 (the positive electrode 41) and the outer package can 10 is suppressed. Accordingly, it is possible to achieve higher effects.

In this case, one or both of the upper end part 43M and the lower end part 43N may be extended horizontally, and thus one or both of the upper end part and the lower end part of the positive electrode 41 may be shielded by the separator 43. This allows further suppression of the short circuit between the battery device 40 (the positive electrode 41) and the outer package can 10. Accordingly, it is possible to achieve even higher effects.

Moreover, a portion of the positive electrode lead 71 may be so bent as to be along the battery device 40, and the portion of the positive electrode lead 71 may thus dig into a portion of the separator 43, i.e., the upper end part 43M, that shields the positive electrode 41. This allows, for a reason described below, the secondary battery to be prevented from being easily damaged even upon undergoing an external force such as vibration or shock. Accordingly, it is possible to achieve even higher effects.

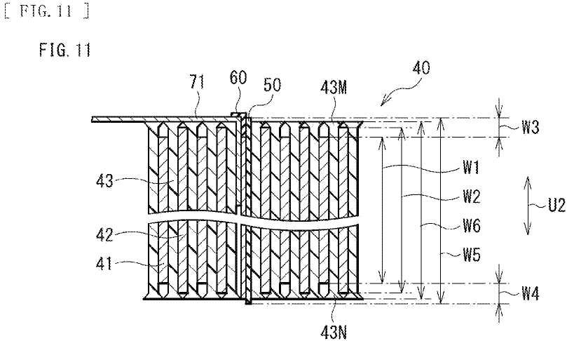

FIG. 11 illustrates a sectional configuration of a main part of a secondary battery according to a second reference example, and corresponds to FIG. 7. The secondary battery according to the second reference example has a configuration similar to that of the secondary battery according to the present embodiment (FIG. 7) except that the positive electrode lead 71 does not dig into the separator 43 (the upper end part 43M).

In the secondary battery according to the second reference example, as illustrated in FIG. 11, the positive electrode lead 71 does not dig into the upper end part 43M, and thus the positive electrode lead 71 is not held by the separator 43 via the recessed part 43H. In this case, if the secondary battery undergoes an external force such as vibration or shock, the positive electrode lead 71 easily moves inside the outer package can 10, and as a result, the positive electrode lead 71 can be damaged.

In contrast, in the secondary battery according to an embodiment, as illustrated in FIG. 7, the positive electrode lead 71 digs into the upper end part 43M, and thus the positive electrode lead 71 is supported by the separator 43 via the recessed part 43H. In this case, even if the secondary battery undergoes an external force, the positive electrode lead 71 is prevented from easily moving inside the outer package can 10. The positive electrode lead 71 is thus prevented from being easily damaged. As a result, the secondary battery is prevented from being easily damaged even upon undergoing an external force. Accordingly, it is possible to achieve even higher effects.

Further, the positive electrode lead 71 may be coupled to the positive electrode 41 on the inner side of the winding of the positive electrode 41 relative to the outermost wind of the positive electrode 41. This suppresses corrosion of the outer package can 10 resulting from creeping up of the electrolytic solution. Accordingly, it is possible to achieve higher effects.

Further, the secondary battery may have a flat and columnar shape, that is, the secondary battery may be one referred to by a term such as a coin type or a button type. Even in a case of such a small-sized secondary battery which is highly constrained in terms of size, the secondary battery is manufactured stably while a short circuit is suppressed. Accordingly, it is possible to achieve higher effects.

Further, the secondary battery may include a lithium-ion secondary battery. This makes it possible to obtain a sufficient battery capacity stably through the use of insertion and extraction of lithium. Accordingly, it is possible to achieve higher effects.

The configuration of the secondary battery described above is appropriately modifiable, as described below according to an embodiment. Note that any two or more of the following series of modifications may be combined with each other.

In FIG. 4, the positive electrode 41 includes one exposed part 41R1, and accordingly, one insulating tape 50 is provided on the positive electrode 41 (the positive electrode current collector 41A at the exposed part 41R1). However, the number of insulating tapes 50 is not particularly limited, and may be chosen as desired.

Specifically, the positive electrode 41 may include a plurality of exposed parts 41R1, and accordingly, a plurality of insulating tapes 50 may be provided on the positive electrode 41 (the positive electrode current collector 41A at the plurality of exposed parts 41R1). In this case also, as long as the above-described condition is satisfied regarding the width ratio (W3 +W4)/(W2 - W1), the secondary battery is manufactured stably while a short circuit is suppressed at each of the insulating tapes 50. Accordingly, it is possible to achieve similar effects.

In FIG. 4, the positive electrode 41 includes one exposed part 41R2. Accordingly, one positive electrode lead 71 is coupled to the positive electrode 41 (the positive electrode current collector 41A at the exposed part 41R2), and one insulating tape 60 is provided on the positive electrode lead 71. However, there is no particular limitation to the number of positive electrode leads 71 or the number of insulating tapes 60. Thus, the number of positive electrode leads 71 and the number of insulating tapes 60 may each be chosen as desired.

Specifically, the positive electrode 41 may include a plurality of exposed parts 41R2. Accordingly, a plurality of positive electrode leads 71 may be coupled to the positive electrode 41 (the positive electrode current collector 41A at the plurality of exposed parts 41R2), and a plurality of insulating tapes 60 may be provided on the plurality of positive electrode leads 71. In this case also, a short circuit is suppressed at each of the insulating tapes 60. Accordingly, it is possible to achieve similar effects.

In FIG. 7, the positive electrode lead 71 is pressed against the separator 43 (the upper end part 43M), and thus the positive electrode lead 71 digs into the upper end part 43M. However, the positive electrode 71 may not be pressed against the upper end part 43M and may thus not dig into the upper end part 43M. Even in such a case, it is possible to achieve similar effects.

However, to suppress damage to the secondary battery (the positive electrode lead 71) caused by an external force, it is preferable that the positive electrode lead 71 dig into the upper end part 43M, as described above.

In FIG. 2, the outer package can 10 that is a welded can (a crimpless can) is used. However, although not specifically illustrated here, an outer package can that is a crimped can may be used instead of the outer package can 10 that is a welded can.

The outer package can that is a crimped can has a configuration similar to that of the outer package can 10 that is a welded can, except for including a container part and a cover part that are physically separate from each other, and except that the container part and the cover part are crimped to each other via a gasket.

In this case also, the battery device 40 and other components are contained inside the outer package can that is a crimped can. Accordingly, it is possible to achieve similar effects.

### Examples

Examples of the present technology are described below according to an embodiment.

### Examples 1 to 10 and Comparative Examples 1 and 2

Secondary batteries were fabricated, and thereafter the secondary batteries were evaluated for their performance.

### Fabrication of Secondary Battery

The secondary batteries (lithium-ion secondary batteries) of the flat and columnar shape illustrated in FIGS. 1 to 6 were fabricated in accordance with a procedure described below.

### Fabrication of Positive Electrode

First, 91 parts by mass of the positive electrode active material (LiCoO₂), 3 parts by mass of the positive electrode binder (polyvinylidene difluoride), and 6 parts by mass of the positive electrode conductor (graphite) were mixed with each other to thereby obtain a positive electrode mixture.

Thereafter, the positive electrode mixture was put into an organic solvent (N-methyl-2-pyrrolidone), following which the organic solvent was stirred to thereby prepare a paste positive electrode mixture slurry. Thereafter, the positive electrode mixture slurry was applied on the two opposed surfaces of the positive electrode current collector 41A (a band-shaped aluminum foil having a thickness of 12 µm) by means of a coating apparatus, following which the applied positive electrode mixture slurry was dried to thereby form the positive electrode active material layers 41B. In this case, the range of formation of the positive electrode active material layers 41B was adjusted in such a manner that the exposed parts 41R1 and 41R2 were formed.

Lastly, the positive electrode active material layers 41B were compression-molded by means of a roll pressing machine. In this manner, the positive electrode 41 (400 mm in length L1 and 3.8 mm in width W1) including the exposed parts 41R1 and 41R2 was fabricated.

### Fabrication of Negative Electrode

First, 95 parts by mass of the negative electrode active material (graphite) and 5 parts by mass of the negative electrode binder (polyvinylidene difluoride) were mixed with each other to thereby obtain a negative electrode mixture.

Thereafter, the negative electrode mixture was put into an organic solvent (N-methyl-2-pyrrolidone), following which the organic solvent was stirred to thereby prepare a paste negative electrode mixture slurry. Thereafter, the positive electrode mixture slurry was applied on the two opposed surfaces of the negative electrode current collector 42A (a band-shaped copper foil having a thickness of 15 µm) by means of a coating apparatus, following which the applied negative electrode mixture slurry was dried to thereby form the negative electrode active material layers 42B. In this case, the range of formation of the negative electrode active material layers 42B was adjusted in such a manner that the exposed parts 42R1 and 42R2 were formed.

Lastly, the negative electrode active material layers 42B were compression-molded by means of a roll pressing machine. In this manner, the negative electrode 42 (420 mm in length L2 and 4.3 mm in width W2) including the exposed parts 42R1 and 42R2 was fabricated.

### Preparation of Electrolytic Solution

The electrolyte salt (LiPF₆) was added to the solvent (ethylene carbonate and diethyl carbonate), following which the solvent was stirred. In this case, a mixture ratio (a weight ratio) between ethylene carbonate and diethyl carbonate in the solvent was set to 30:70, and a content of the electrolyte salt was set to 1 mol/kg with respect to the solvent. The electrolyte salt was thereby dissolved or dispersed in the solvent. Thus, the electrolytic solution was prepared.

### Assembly of Secondary Battery

First, by means of a resistance welding method, the positive electrode lead 71 including aluminum was welded to the positive electrode 41 (the positive electrode current collector 41A) at the exposed part 41R2, and the negative electrode lead 72 including nickel was welded to the negative electrode 42 (the negative electrode current collector 42A) at the exposed part 42R2.

Thereafter, the insulating tape 60 (an 18-µm-thick polyimide tape available from Nitto Denko Corporation) was attached to the positive electrode lead 71. In this case, a range of attachment of the insulating tape 60 was so adjusted as to allow the insulating tape 60 to overlap in part with the insulating tape 50 and not to overlap with the positive electrode 41.

Thereafter, the insulating tape 50 (an 18-µm-thick polyimide tape available from Nitto Denko Corporation) was attached to the positive electrode current collector 41A exposed in the exposed part 41R1 in such a manner that the insulating tape 50 overlay the positive electrode active material layer 41B (the portions P1 and P2). In this case, the width W5 of the insulating tape 50 was adjusted to vary each of the widths W3 and W4, while the widths W3 and W4 were set to be equal to each other. The width ratio (W3 + W4)/(W2 -W1) which is the dimensional condition for the secondary battery was thereby varied as listed in Table 1.

Thereafter, the positive electrode 41 and the negative electrode 42 were stacked on each other with the separator 43 (a polyethylene film having the width W6 of 5.8 mm and a thickness of 10 µm) interposed therebetween, following which the stack of the positive electrode 41, the negative electrode 42, and the separator 43 was wound to thereby fabricate the wound body 40Z.

Thereafter, the wound body 40Z was placed into the container part 11 through the opening 11K. In this case, the negative electrode lead 72 was welded to the container part 11 by means of a resistance welding method.

Thereafter, the electrolytic solution was injected into the container part 11 through the opening 11K, following which the cover part 12 with the external terminal 20 attached thereto via the gasket 30 was welded to the container part 11 by means of a laser welding method. In this case, the positive electrode lead 71 was welded to the external terminal 20 by means of a resistance welding method. The wound body 40Z (including the positive electrode 41, the negative electrode 42, and the separator 43) was thus impregnated with the electrolytic solution. In this manner, the battery device 40 was fabricated, and the cover part 12 was joined to the container part 11 to thereby form the outer package can 10. As a result, the components including, without limitation, the battery device 40 and the insulating tape 50 were sealed in the outer package can 10. Thus, the secondary battery was assembled.

### Stabilization of Secondary Battery

The secondary battery after being assembled was charged and discharged for one cycle in an ambient temperature environment (at a temperature of 23° C.). Upon the charging, the secondary battery was charged with a constant current of 0.1 C until a voltage reached 4.2 V, and was thereafter charged with a constant voltage of that value of 4.2 V until a current reached 0.05 C. Upon the discharging, the secondary battery was discharged with a constant current of 0.1 C until the voltage reached 3.0 V. Note that 0.1 C is a value of a current that causes the battery capacity (a theoretical capacity) to be completely discharged in 10 hours, and 0.05 C is a value of a current that causes the battery capacity to be completely discharged in 20 hours.

As a result, a film was formed on the surface of, for example, the negative electrode 42 to thereby electrochemically stabilize the state of the secondary battery. Thus, the secondary battery was completed.

The secondary batteries were evaluated for their performance (operational reliability and manufacturing stability). The evaluation revealed the results presented in Table 1.

In a case of evaluating the operational reliability, a drop test was carried out on the secondary battery to examine whether a short circuit between the battery device 40 (the positive electrode 41) and the outer package can 10 (the cover part 12) occurred. In the drop test, the secondary battery was dropped onto a concrete floor from a position at a height of 1.9 m in accordance with the drop test defined in the Electrical Appliance and Material Safety Act. In this case, a work of dropping the secondary battery to cause one of the bottom part M1, the bottom part M2, or the sidewall part M3 to collide with the floor was carried out three times each for the bottom part M1, the bottom part M2, and the sidewall part M3; thus, the secondary battery was dropped nine times in total. Further, a work of examining the presence or absence of the short circuit after the drop test (nine drops) was repeated 20 times (that is, 20 secondary batteries were subjected to the drop test). The number of secondary batteries in which the short circuit occurred (the number of short-circuit defects) was thereby examined.

In a case of evaluating the manufacturing stability, whether the cover part 12 was properly weldable to the container part 11 was examined after placing of the wound body 40Z into the container part 11 in the process of manufacturing the secondary battery. In this case, a work of examining whether a gap was present between the container part 11 and the cover part 12 due to the presence of the insulating tape 50 after welding of the cover part 12 to the container part 11 was repeated 20 times (that is, 20 secondary batteries were subjected to the examination at the time of manufacture). The number of secondary batteries in which the gap was present (the number of sealing defects) was thereby examined. [Table 1]

Table 1

(Number of secondary batteries subjected to drop test = 20; Number of secondary batteries subjected to examination at time of manufacture = 20)

| | Width ratio (W3 + W4)/(W2 - W1) | Number of short-circuit defects after drop test | Number of sealing defects at time of manufacture |
|---|---|---|---|
| Comparative Example 1 | 0.00 | 20 | 0 |
| Example 1 | 0.50 | 8 | 0 |
| Example 2 | 1.00 | 5 | 0 |
| Example 3 | 1.50 | 3 | 0 |
| Example 4 | 1.75 | 1 | 0 |
| Example 5 | 2.00 | 0 | 0 |
| Example 6 | 2.25 | 0 | 0 |
| Example 7 | 2.50 | 0 | 0 |
| Example 8 | 2.75 | 0 | 0 |
| Example 9 | 2.94 | 0 | 2 |
| Example 10 | 3.00 | 0 | 5 |
| Comparative Example 2 | 3.20 | 0 | 8 |

As indicated in Table 1, the operational reliability and the manufacturing stability of the secondary battery varied depending on the dimensional condition for the secondary battery, that is, the width ratio (W3 + W4)/(W2 - W1).

Specifically, in a case where the width ratio (W3 + W4)/(W2 - W1) was less than 0.50 (Comparative example 1), the short-circuit defect occurred although no sealing defect occurred. In this case, in particular, the short-circuit defect occurred in all the number of the secondary batteries.

Further, in a case where the width ratio (W3 + W4)/(W2 - W1) was greater than 3.00 (Comparative example 2), the sealing defect occurred although no short-circuit defect occurred. In this case, in particular, the sealing defect occurred in about half the number of secondary batteries.

In contrast, in a case where the width ratio (W3 + W4)/(W2 - W1) was within a range from 0.50 to 3.00 both inclusive (Examples 1 to 10), either the short-circuit defect or the sealing defect occurred in some cases; however, the number of short-circuit defects and the number of sealing defects were each sufficiently suppressed to be less than half. In this case, in particular, neither the short-circuit defect nor the sealing defect occurred if the width ratio (W3 + W4)/(W2 - W1) was within a range from 2.00 to 2.75 both inclusive (Examples 5 to 8).

### Example 11

As illustrated in FIG. 7 and described in Table 2, secondary batteries were fabricated in accordance with a similar procedure except that the upper end part 43M and the lower end part 43N of the separator 43 were each extended by making use of heat treatment, and the upper end part and the other end part of the positive electrode 41 were shielded using the upper end part 43M and the lower end part 43N, respectively. Thereafter, the secondary batteries were evaluated for their performance (operational reliability).

In a case of fabricating the secondary battery, the wound body 40Z was fabricated and thereafter, the upper end part 43M and the lower end part 43N of the separator 43 were each subjected to a heat treatment (at a heating temperature of 100° C.) to thereby cause each of the upper end part 43M and the lower end part 43N to be extended horizontally by making use of the heat treatment (thermal deformation or thermal contraction). In this case, the heat treatment was carried out until the width W6 of the separator 43 became smaller than the width W5 of the insulating tape 50.

In a case of evaluating the operational reliability of the secondary battery, a similar procedure was followed except that a vibration test was carried out instead of the drop test, and the number of secondary batteries subjected to the test was changed from 20 to 10. The vibration test is a test under a severer condition than the drop test in examining the presence or absence of a short circuit in the secondary battery.

A testing method of the vibration test was in accordance with the Electrical Appliance and Material Safety Act, and testing conditions were as follows: amplitude, 0.8 mm; frequency, 10 Hz to 55 Hz; sweep rate, 1 Hz/min; and vibration direction, three-axis directions orthogonal to each other (an X-axis direction, a Y-axis direction, and a Z-axis direction). In a case of examining the presence or absence of the short circuit after the vibration test, it was checked whether any of rupture, ignition, gas ejection, and liquid leakage (leakage of the electrolytic solution) occurred in the secondary battery in a state of having been left to stand for one hour after the vibration test. [Table 2]

Table 2

(Number of secondary batteries subjected to vibration test = 10)

| | Width ratio (W3 + W4)/(W2 - W1) | Shielding by separator | Number of short-circuit defects after vibration test |
|---|---|---|---|
| Example 5 | 2.00 | No | 5 |
| Example 11 | 2.00 | Yes | 0 |

As indicated in Table 2, the short-circuit defect occurred in a case where the positive electrode 41 was not shielded using the separator 43, i.e., the upper end part 43M (Example 5), whereas no short-circuit defect occurred in a case where the positive electrode 41 was shielded using the upper end part 43M (Example 11).

### Conclusion

The results presented in Tables 1 and 2 indicate that, if the condition represented by Expression (1), i.e., 0.50 ≤ (W3 + W4)/(W2 - W1) ≤ 3.00, was satisfied regarding the width ratio (W3 + W4)/(W2 - W1) representing the relationship between the width W1 of the positive electrode 41, the width W2 of the negative electrode 42, and the widths W3 and W4 of the insulating tape 50, the occurrence of each of the short-circuit defect and the sealing defect was suppressed. Accordingly, high operational reliability and superior manufacturing stability were achieved in the secondary battery.

Although the present technology has been described above with reference to one or more embodiments including Examples, the configuration of the present technology is not limited thereto, and is therefore modifiable in a variety of ways.

Specifically, although the description has been given of the case where the electrode reactant is lithium, the electrode reactant is not particularly limited. Accordingly, the electrode reactant may be another alkali metal such as sodium or potassium, or may be an alkaline earth metal such as beryllium, magnesium, or calcium, as described above. In addition, the electrode reactant may be another light metal such as aluminum.

The effects described herein are mere examples, and effects of the present technology are therefore not limited to those described herein. Accordingly, the present technology may achieve any other suitable effect.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
an outer package member;
a battery device contained inside the outer package member, the battery device including a positive electrode and a negative electrode, the positive electrode and the negative electrode being opposed to each other and being wound; and
an insulating member provided on the positive electrode, wherein
the positive electrode includes a positive electrode current collector, and a positive electrode active material layer provided on the positive electrode current collector,
the negative electrode includes a negative electrode current collector, and a negative electrode active material layer provided on the negative electrode current collector on a side opposed to the positive electrode active material layer,
the positive electrode includes an exposed part in which the positive electrode active material layer is not provided and the positive electrode current collector is exposed,
the exposed part is opposed to the negative electrode active material layer,
the insulating member covers at least the exposed part,
the positive electrode has a first direction along which the positive electrode active material layer is provided intermittently via the exposed part on the positive electrode current collector, and a second direction intersecting the first direction,
in the second direction, the negative electrode protrudes relative to the positive electrode toward opposite sides,
further, in the second direction, the insulating member protrudes relative to the positive electrode toward the opposite sides, and
a dimension of the positive electrode in the second direction, a dimension of the negative electrode in the second direction, a dimension of protrusion of the insulating member relative to the positive electrode on one of the opposite sides in the second direction, and a dimension of protrusion of the insulating member relative to the positive electrode on another of the opposite sides in the second direction satisfy a relationship represented by Expression (1) below,
$$0.50 \leq \left(\text{W3+W4}\right) / \left(\text{W2} - \text{W1}\right) \leq 3.00$$
.
where
W1 is the dimension of the positive electrode in the second direction,
W2 is the dimension of the negative electrode in the second direction,
W3 is the dimension of protrusion of the insulating member relative to the positive electrode on the one of the opposite sides in the second direction, and
W4 is the dimension of protrusion of the insulating member relative to the positive electrode on the other of the opposite sides in the second direction.

2. The secondary battery according to claim 1, wherein a relationship represented by Expression (2) below is satisfied:
$$2.00 \leq \left(\text{W3+W4}\right) / \left(\text{W2} - \text{W1}\right) \leq 2.75$$
.

3. The secondary battery according to claim 1, wherein
the positive electrode active material layer includes
a first portion located on one side in the first direction relative to the exposed part, and
a second portion located on another side in the first direction relative to the exposed part, and
the insulating member overlies one or both of the first portion and the second portion.

4. The secondary battery according to claim 1, wherein
the positive electrode includes another positive electrode active material layer provided on the positive electrode current collector on a side opposite to a side opposed to the negative electrode,
the positive electrode includes, at a position corresponding to the exposed part, another exposed part in which the other positive electrode active material layer is not provided and the positive electrode current collector is exposed,
the secondary battery further includes
a wiring member coupled to the positive electrode current collector at the other exposed part, the wiring member protruding relative to the positive electrode current collector in the second direction, and
another insulating member covering the wiring member on the side opposed to the negative electrode, and
the other insulating member overlaps in part with the insulating member.

5. The secondary battery according to claim 4, wherein the other insulating member does not overlap with the positive electrode.

6. The secondary battery according to claim 1, further comprising a separator having an insulating property, the separator being disposed between the positive electrode and the negative electrode, wherein
the separator protrudes relative to the negative electrode toward the opposite sides in the second direction, and
the insulating member protrudes relative to the separator toward the opposite sides in the second direction.

7. The secondary battery according to claim 6, wherein one or both of one end part and another end part of the separator in the second direction shield one or both of one end part and another end part of the positive electrode in the second direction.

8. The secondary battery according to claim 7, further comprising a wiring member coupled to the positive electrode, wherein
a portion of the wiring member is so bent as to be along the battery device, and digs into a portion of the separator that shields the positive electrode.

9. The secondary battery according to claim 1, further comprising a wiring member coupled to the positive electrode, wherein
the wiring member is coupled to the positive electrode on an inner side of winding of the positive electrode relative to an outermost wind of the positive electrode.

10. The secondary battery according to claim 1, wherein the outer package member includes
a container member having an opening, the container member containing the battery device inside, and
a cover member closing the opening, the cover member being welded to the container member.

11. The secondary battery according to claim 1, wherein the secondary battery has a flat and columnar shape.

12. The secondary battery according to claim 1, wherein the secondary battery comprises a lithium-ion secondary battery.
